(19) United States
(12) Patent Application Publication
(10) Pub. No.: US 2025/0285648 A1
(43) Pub. Date: Sep. 11, 2025

(54) IMAGE EDITING ASSISTANCE METHOD AND IMAGE EDITING APPARATUS

(71) Applicant: CJ Olivenetworks Co., Ltd., Seoul (KR)

(72) Inventors: Sang Gi RYU, Seoul (KR); Chi Hoon Lee, Seoul (KR); Yi An Seo, Seoul (KR); Yae Ha Kwon, Seoul (KR); Jong Soo Sohn, Seoul (KR); Jee In Kim, Seoul (KR); Jong In Bae, Seoul (KR)

(21) Appl. No.: 19/218,230

(22) Filed: May 24, 2025

Related U.S. Application Data
(63) Continuation of application No. PCT/KR2023/019274, filed on Nov. 27, 2023.

(30) Foreign Application Priority Data
Nov. 25, 2022 (KR) 10-2022-0159886

(51) Int. Cl. G11B 27/031; G06V 20/40

(52) U.S. Cl. CPC G11B 27/031; G06V 20/42; G06V 20/44; G06V 20/46

(57) ABSTRACT

An image editing assistance method and an image editing assistance apparatus are provided. An image editing assistance method according to the present disclosure may include preprocessing a broadcast video of an event for which a game time period for each round is specified to identify a game progress section from which a game non-progress sections has been removed from the broadcast video, extracting a plurality of video clips from the game progress section, and analyzing the plurality of video clips using an event detection model to generate editing guide information indicating at least one valid section within the game progress section, the valid section corresponding to at least one of a plurality of event types.

### TECHNICAL FIELD

The present disclosure relates to image editing technology, and more particularly, to a method and apparatus of automatically selecting highlight scenes desired by a user as an editor from broadcast videos of sports events based on deep learning to assist the user's image editing work.

### BACKGROUND ART

The domestic over-the-top (OTT) usage rate has increased rapidly from about 41% in 2019 to about 82% in 2021, creating an environment where a lot of video content can be viewed anytime and anywhere, but the consumption of sports-related video content is relatively low.

In particular, except for a few sports or leagues with a strong fan base, efficient consumption of broadcast video content has not been achieved compared to efforts to secure broadcasting rights on OTT platforms, and more popular content itself such as movies and dramas has a high level member attraction, but in contrast, sports content for sports such as soccer and basketball remains in the role of bait products to induce OTT subscriptions.

The MZ generation, which is the largest consumer group of video content, has a tendency to watch short videos multiple times on a regular basis instead of watching long videos infrequently, and unless a sports game is being broadcast in real time, not limited to the MZ generation, the preference for highlight videos consisting of key impactful scenes from full recorded videos is also gradually increasing.

Meanwhile, the extraction of highlight videos from broadcast videos is mostly carried out manually by a human, that is, an editor, and such an editing method not only takes a long time, but also involves the editor's subjective judgment, mistakes, or the like, thereby causing a disadvantage of producing highlight videos of lower quality than the expectations of general content consumers.

Several software functions that assist image editing have been proposed to solve the aforementioned disadvantage. For example, there are provided a remix function that intelligently rearranges music/voice so that audio data and image data match each other, speech-to-text technology that enables high-speed caption creation, and HDR content export technology through GPU acceleration.

However, although there are some differences depending on the event, most sports games involve intense movements, there are many participating players, and angle changes occur frequently due to multiple broadcasting cameras, thereby making it difficult to precisely capture the characteristics of momentary scenes during the game.

In addition, for example, in soccer, major events such as goals that have a decisive influence on victory or defeat may be created through play over a certain period of time, and even for the same type of event, a length of time period each event lasts within a game may be varied, thereby making it difficult to uniformly extract video sections for each event.

### DISCLOSURE OF INVENTION

### Technical Problem

The present disclosure is contrived to solve the foregoing problems, and an aspect of the present disclosure is to provide a method and apparatus of extracting, from a broadcast video of a sports game, a video section (game progress section) in which the game is actually played by automatically removing a video section (game non-progress section) outside the game.

Furthermore, another aspect of the present disclosure is to provide a method and apparatus of identifying a valid section in which a specific event occurs within a game progress section extracted from a broadcast video to provide the identified valid section to an editor (user) as editing guide information.

These and other objects and advantages of the present disclosure will be understood from the following description and will be apparent from embodiments of the present disclosure. In addition, it will be readily apparent that the objects and advantages of the present disclosure can be realized by means and combinations thereof indicated in the claims.

### Solution to Problem

To accomplish the above mentioned objects, according to one aspect of the present invention, there is provided an image editing assistance method, the method comprising the steps of: preprocessing a broadcast video of an event for which a game time period for each round is specified to identify a game progress section from which a game non-progress sections has been removed from the broadcast video; extracting a plurality of video clips from the game progress section; and analyzing the plurality of video clips using an event detection model to generate editing guide information indicating at least one valid section within the game progress section, the valid section corresponding to at least one of a plurality of event types.

Further, the image editing assistance method may include the steps of: acquiring the game progress section; sampling at least one reference frame from the broadcast video; generating reference time information indicating an estimate value of at least one of a start time and an end time of at least one round in the broadcast video based on the reference frame; and removing the game non-progress section from the broadcast video based on the reference time information.

Further, the step of generating of the reference time information may include the steps of: extracting a broadcast scoreboard from the reference frame; determining, from the broadcast scoreboard, an elapsed time period from the start time of at least one round; and estimating, based on the elapsed time period, at least one of a start time and an end time of at least one round.

Further, the event detection model may be trained by a learning data set including a plurality of highlight videos extracted from a plurality of different videos of the same event and labeled with any one of the plurality of event types.

Further, an end time of a preceding video clip may be subsequent to a start time of a following video clip between two adjacent video clips of the plurality of video clips.

Further, the step of generating of the editing guide information may include the steps of: converting the plurality of video clips into a plurality of feature vectors corresponding thereto on a one-to-one basis, using a first deep learning model of the event detection model; and following operations using a second deep learning model of the event detection model, wherein the following operations include mapping each of the plurality of feature vectors to any one of a plurality of clusters, each cluster at least partially representing at least one of the plurality of event types; grouping the plurality of feature vectors in chronological order to generate a plurality of vector groups; and identifying the valid section within the game progress section from a correspondence relationship between the plurality of vector groups and at least one of the plurality of event types.

Further, the image editing assistance method may include the step of receiving setting information on at least one of a plurality of filtering items used to extract a highlight video from the broadcast video, wherein the second deep learning model is operated according to the setting information.

Moreover, the plurality of filtering items may comprise an event type, an event similarity, and an event importance.

Further, the image editing assistance method may include the step of: outputting an image editing interface presented with the editing guide information, wherein the image editing interface comprises an indicator indicating the location or range of the valid section in the broadcast video.

Further, the image editing assistance method may include the step of: processing, in response to receiving an automatic editing request specified with a desired time period from a user, the at least one valid section to generate a recommended highlight video having the same time length as the desired time period.

To accomplish the above mentioned objects, according to another aspect of the present invention, there is provided an image editing assistance apparatus, the apparatus comprising: a memory that stores a computer program in which instructions for executing an image editing assistance method are recorded and a broadcast video of an event for which a game time period for each round is specified; and a processor operably coupled to the memory, wherein when the computer program is executed by the processor, the processor is configured to preprocess the broadcast video to acquire a game progress section from which a game non-progress sections has been removed from the broadcast video, extract a plurality of video clips from the game progress section, and analyze the plurality of video clips using an event detection model to generate editing guide information indicating at least one valid section within the game progress section, the valid section corresponding to at least one of a plurality of event types.

Moreover, in order to identify the game progress section, the processor may be configured to sample at least one reference frame from the broadcast video, generate reference time information representing an estimate value of at least one of a start time and an end time of at least one round in the broadcast video based on the reference frame, and remove the game non-progress section from the broadcast video based on the reference time information.

Moreover, in order to generate the reference time information, the processor may be configured to extract a broadcast scoreboard from the reference frame, determine, from the broadcast scoreboard, an elapsed time period from a start time of at least one round, and estimate, based on the elapsed time period, at least one of a start time and an end time of at least one round.

Moreover, in order to generate the editing guide information, the processor may be configured to convert the plurality of video clips into a plurality of feature vectors corresponding thereto on a one-to-one basis using a first deep learning model of the event detection model, map each of the plurality of feature vectors to any one of a plurality of clusters, each cluster at least partially representing at least one of the plurality of event types, using a second deep learning model of the event detection model, group the plurality of feature vectors in chronological order to generate a plurality of vector groups, and identify the valid section within the game progress section from a correspondence relationship between the plurality of vector groups and at least one of the plurality of event types.

Moreover, the processor may be configured to operate, when receiving setting information on at least one of a plurality of filtering items used to extract a highlight video from the broadcast video, the second deep learning model according to the setting information.

### Advantageous Effects of Invention

According to at least one of the embodiments of the present disclosure, a video section (game progress section) in which a game is actually played may be extracted, from a broadcast video of a sports game, by automatically removing a video section (game non-progress section) outside the game. Accordingly, compared to a method of searching for a highlight section for an entire sports broadcast video, the waste of hardware and software computing resources may be greatly reduced, and an editor's work may be greatly saved.

Furthermore, according to at least one of the embodiments of the present disclosure, a valid section in which a specific event occurs within a game progress section extracted from the broadcast video may be identified and provided to the editor (user) as editing guide information. Accordingly, the editor may intuitively identify the location or range of a video section where the type of event he or she wants to happen, shorten a time period it takes to produce a complete version of an edited video, and reduce the possibility of highlight videos being mis-extracted in sections that are significantly less relevant to key scenes of the game.

The effects of the present disclosure are not limited to the above-mentioned effects, and other effects that are not mentioned herein will be clearly understood by those skilled in the art from the description of the claims.

### BRIEF DESCRIPTION OF DRAWINGS

The accompanying drawings illustrate a preferred embodiment of the present disclosure, and together with the foregoing disclosure, serve to provide further understanding of the technical features of the present disclosure, and thus, the present disclosure is not construed as being limited to the drawings.

FIG. 1 is a diagram illustratively showing a configuration of an image editing assistance apparatus according to the present disclosure.

FIG. 2 is a flowchart referenced to illustratively describe an image editing assistance method according to an embodiment of the present disclosure, which is executed by the image editing assistance apparatus shown in FIG. 1.

FIGS. 3 to 5 are diagrams referenced to describe an illustrative execution process of subroutines in step S220 shown in FIG. 2.

FIG. 6 is a diagram referenced to describe an illustrative process in which a plurality of video clips extracted from a game progress section are converted into a plurality of feature vectors.

FIG. 7 is a diagram illustrating a plurality of event types predefined for each event and detection criteria for each event type in a table format.

FIG. 8 is a diagram illustratively showing a portion of learning data labeled according to the detection criteria for each event type according to FIG. 7.

FIG. 9 is a flowchart referenced to describe an illustrative execution process of the subroutines in step S240.

FIG. 10 is a diagram illustratively showing a correspondence relationship between a plurality of clusters and a plurality of feature vectors.

FIG. 11 is a diagram referenced to describe a process of performing event detection for each sub-video section of a game progress video from corresponding relationship data according to FIG. 10.

FIG. 12 is a flowchart referenced to illustratively describe an image editing assistance method according to another embodiment of the present disclosure, which is executed by the image editing assistance apparatus shown in FIG. 1.

100: Image editing assistance apparatus 110: Input unit 120: Output unit 121: Display 122: Speaker 130: Control unit 131: Input/output interface 132: Memory 133: Processor 134: Data bus

### MODE FOR THE INVENTION

The details of the objects and technical configurations of the present disclosure and operational effects thereof will be more clearly understood from the following detailed description based on the accompanying drawings appended hereto. Hereinafter, embodiments according to the present disclosure will be described in detail with reference to the accompanying drawings.

Embodiments disclosed herein should not be interpreted as limiting or used to limit the scope of the present disclosure. It is apparent for those skilled in the art that a description including embodiments herein has various applications. Therefore, any embodiments described in the detailed description of the present disclosure are illustrative for better understanding of the present disclosure and are not intended to limit the scope of the present disclosure to the embodiments.

Functional blocks illustrated in the drawings and described hereunder are only examples of possible implementations. In other implementations, other functional blocks may be used without departing from the concept and scope of the detailed description. Furthermore, one or more functional blocks of the present disclosure are illustrated as separate blocks, but one or more of the functional blocks of the present disclosure may be a combination of various hardware and software elements that execute the same function.

terms including ordinals, such as first, second, etc., are used for the purpose of distinguishing one of various components from the others, and are not used to limit the components by such terms.

In addition, an expression that some elements are “included” is an expression of an “open type”, and the expression simply denotes that the corresponding elements are present, but should not be construed as excluding additional elements.

Moreover, in case where it is mentioned that one element is “connected” or “coupled” to the other element, it should be understood that one element may be directly connected to the other element, but another element may be present therebetween.

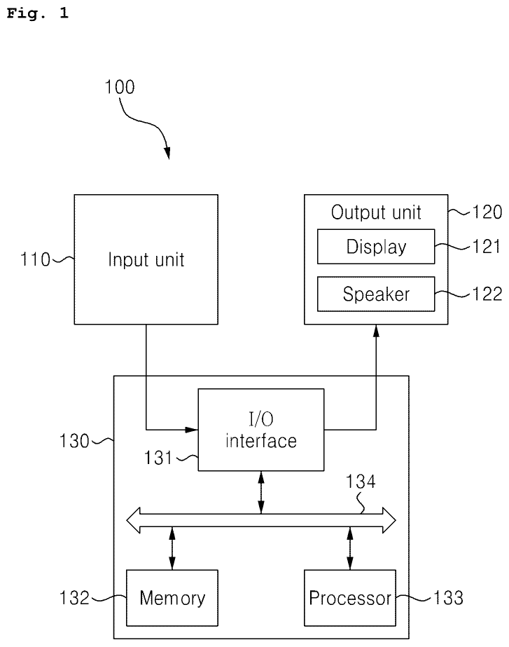

FIG. 1 is a diagram illustratively showing a configuration of an image editing assistance apparatus 100 according to the present disclosure.

Referring to FIG. 1, the image editing assistance apparatus 100 includes an input unit 110, an output unit 120, and a control unit 130. The image editing assistance apparatus 100 may be implemented in the form of a desktop, a laptop, a smartphone, tablet PC, or the like.

The input unit 110 receives a series of inputs (an action of requesting for execution of an editing-related function) from a user (editor) who wishes to produce highlight video content through editing of any sports broadcast video through the image editing assistance apparatus 100, and transmits a signal of requesting for execution of the function associated with each input to the control unit 130. The input unit 110 may be any one or a combination of two or more of known input device such as a keyboard, a mouse, a touch panel, and the like.

The output unit 120 includes a display 121 and a speaker 122. The display 121 displays an image editing interface that provides editing tools for certain sports broadcast videos according to control commands from the control unit 130. The speaker 122 may generate auditory feedback corresponding to audio data time-synchronized with graphic information displayed on the display 121 according to a control command from the control unit 130.

The control unit 130 includes an input/output (I/O) interface 131, a memory 132, and a processor 133, and a data bus 134 that connects them to enable communication.

The input/output interface 131 transmits a user request from the input unit 110 to the processor 133 through the data bus 134, and the processor 133 processes the user request and transmits an output signal generated therefrom to the output unit 120.

The memory 132 records learning models, computer programs, and/or data required to assist the creation of certain sports broadcast videos and highlight videos including video sections desired by an editor. According to hardware implementation, the memory 132 may include at least one or two or more types of storage media from among a flash memory type, a hard disk type, a solid state disk (SSD) type, a silicon disk drive (SDD) type, a multimedia card micro type, a random access memory (RAM), a static random access memory (SRAM), a read-only memory (ROM), an electrically erasable programmable read-only memory (EEPROM), and a programmable read-only memory (PROM). The memory 132 may include a storage medium storing a computer program in which instructions for executing an image editing assistance method according to the present disclosure are recorded.

The processor 133 is operably coupled to the input/output interface 131 and the memory 132 to control an overall operation of the image editing assistance apparatus 100. According to hardware implementation, the processor 133 may include at least one of application specific integrated circuits (ASICs), digital signal processors (DSPs), digital signal processing devices (DSPDs), programmable logic devices (PLDs), field programmable gate arrays (FPGAs), microprocessors, and electric units for the implementation of other functions.

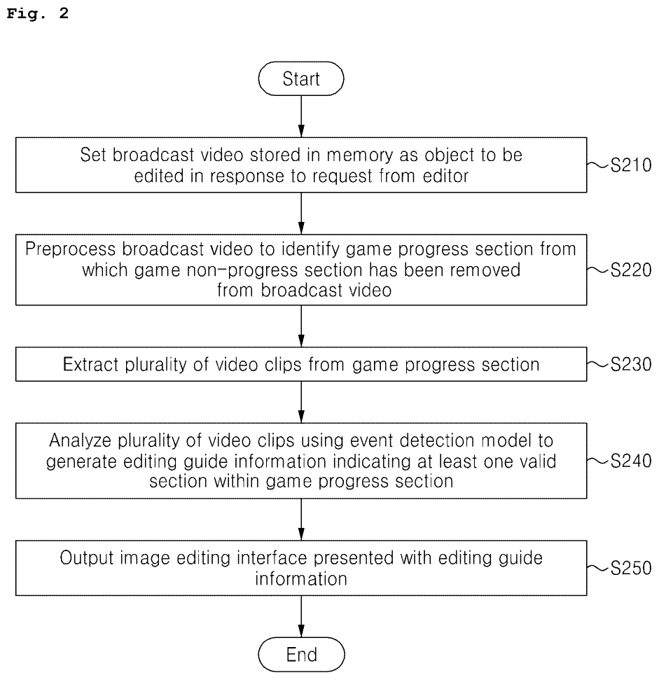

FIG. 2 is a flowchart referenced to illustratively describe an image editing assistance method according to an embodiment of the present disclosure, which is executed by the image editing assistance apparatus shown in FIG. 1.

Referring to FIG. 2, in step S210, the processor 133 sets a broadcast video stored in the memory 132 as an object to be edited in response to a request from an editor received through the input unit 110. A sport (game) of an event subject to editing assistance according to the present disclosure is an event for which a game time period for each round is specified. Here, a round is a time period in which an entire progress of the sport is divided in order, which may be referred to differently depending on the event.

For an example, the first and second halves of soccer, and the first to fourth quarters basketball correspond to ‘rounds’ according to the present disclosure. Incidentally, each round is specified to be 45 minutes in soccer, and each quarter is specified to be 10 or 12 minutes in basketball. In addition, in the case of a sport including two or more rounds, a halftime period between two adjacent rounds may also be specified, and a game time period for each round and a halftime period between rounds may be recorded in advance in the memory 132 as game rule information related to an event in a broadcast video selected in step S210.

In step S220, the processor 133 preprocesses the broadcast video to identify a game progress section from which a game non-progress section has been removed from the broadcast video.

Specifically, a broadcast video for a game of any sport may be a recording related to the game, and the broadcast video usually includes not only a video filmed while the game is actually in progress, but also portions before the start of the game and after the end of the game.

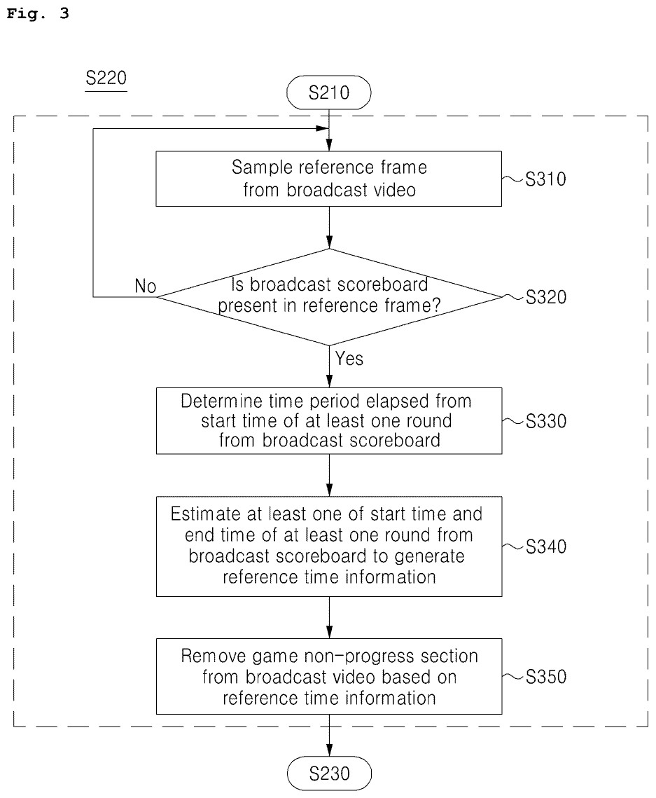

For example, in a soccer game, introductions of commentators and players of both teams are provided before the start of the first half, commentary on the game in the first half or advertisements are provided during a halftime period between the first and second halves, and summary comments on a result of the game, a future schedule (tournament bracket) or the like are provided after the end of the second half. That is, in step S220, the game non-progress section, which is a video portion outside a time period range in which the game is actually played, is removed from the broadcast video. Removing a game non-progress section from a broadcast video may refer to deleting the game non-progress section, but it may even include the meaning of identifying a game progress section, which is a remaining section other than the game non-progress section. The detailed process of step S220 will be described in more detail below with reference to FIGS. 3 to 5.

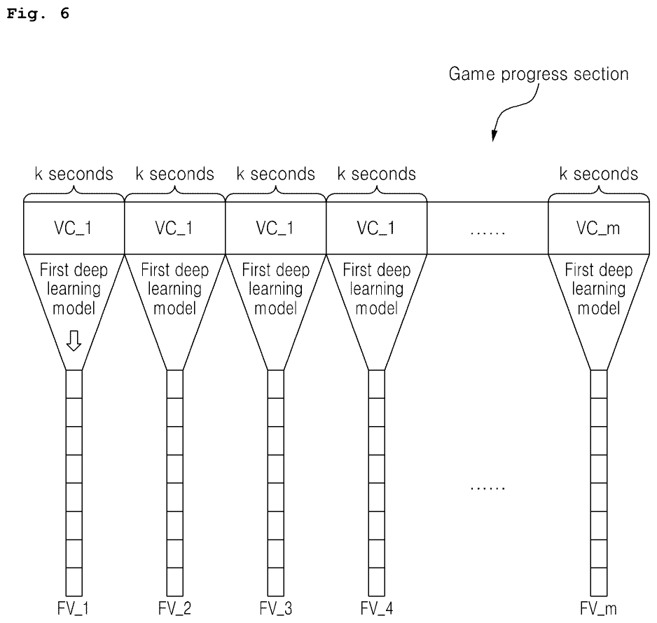

In step S230, the processor 133 extracts a plurality of video clips (see FIG. 6) from a game progress section. Each video clip, which is one image manipulation within the game progress section, and the plurality of video clips extracted in step S230 may all have the same time length, and alternatively, at least one of the plurality of video clips may be different from the remaining video clips.

In a plurality of video clips, video clips adjacent to each other may constitute a single clip pair, and an end time of a preceding video clip of any clip pair may be the same as a start time of a following video clip.

Alternatively, an end time of a preceding video clip of any clip pair may precede a start time of a following video clip. That is, two video clips of any clip pair may have overlapping portions within a certain time period range. In this case, the two video clips of any clip pair do not represent separate sections of the game progress section, but represent a portion in common with each other, so a specific video clip has a relationship with another video clip that precedes or follows it.

The processor 133 may variably adjust a time length of a video clip to be extracted from an overall time length of the game progress section. For example, a time length of the video clip may be 1/10000 of that of the game progress section. Of course, the time length of the video clip may be set to a fixed value regardless of the time length of the game progress section.

In step S240, the processor 133 analyzes a plurality of video clips using an event detection model to generate editing guide information indicating at least one valid section within the game progress section. The editing guide information may be stored in the memory 132. Here, the valid section may be a portion of the game progress section corresponding to at least one of a plurality of event types. A plurality of event types may be predefined according to a game event of a broadcast video.

The processor 133 functionally includes a learning unit and an inference unit. The learning unit is configured to pre-train an event detection model using a learning data set, and the inference unit is configured to detect a section in which a specific event has occurred within a game progress section using the event detection model trained by the learning unit. An event detection process from the game progress section using the event detection model will be described in detail later with reference to FIGS. 6 to 11.

In step S250, the processor 133 outputs an image editing interface presented with editing guide information. That is, the display 121 displays an image editing interface in response to a command from the processor 133. The image editing interface, which is a type of editing tool for a broadcast video, may include at least one graphic indicator indicating the location, range, and corresponding event type for each valid section within the broadcast video.

Meanwhile, prior to step S240, the processor 133 may receive setting information on at least one of a plurality of filtering items used to extract a highlight video from a broadcast video through the input unit 110.

The plurality of filtering items include at least one of an event type, an event similarity, and an event importance, and the setting information received in step S1210 may indicate a setting value for each filtering item. For example, when the game event of the broadcast video is soccer, the event type of the setting information may designate only a few event types (e.g., goals, yellow cards) desired by the editor from among several event types related to soccer. Furthermore, the event similarity may designate a threshold (level) described later as a confidence level used when determining whether or not it corresponds to an event type specified as setting information (i.e., whether it is a correct answer for a specific event). The event importance may designate the importance of each event specified as setting information.

From now on, an illustrative execution process of subroutines in step S220 will be described with reference to FIGS. 3 to 5.

Referring to FIG. 3, in step S310, the processor 133 samples a reference frame from a broadcast video. Here, at least one of static image frames constituting the broadcast video may be sampled as a reference frame. The processor 133 may sample frames within a time period range based on the game rules of the corresponding event from an entire time period section of the broadcast video.

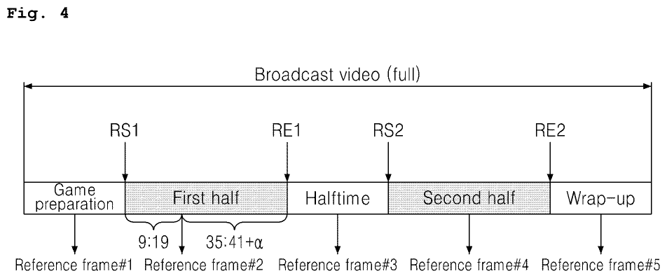

For example, it is assumed that a soccer broadcast video is set as an object to be edited in step S210. Referring to FIG. 4, the soccer broadcast video may be broadly divided into a game preparation section (player introduction, etc.), a first half progress section, a halftime section, a second half progress section, and a game wrap-up section (game content and result information, etc.), and time lengths of respective sections and/or a ratio of time lengths between the sections, and the like may be provided in advance as statistical values.

The processor 133 may sample multiple frames as reference frames at equal time intervals. For example, a total of five reference frames (#1 to #5), one from each of five sections, may be sampled from the broadcast video. Alternatively, the processor 133 may estimate a time period range of the first half progress section and the second half progress section corresponding to the game progress section from among the five sections, and then extract reference frames (#2, #4).

In step S320, the processor 133 determines whether a broadcast scoreboard is present in the reference frames sampled in step S310. Specifically, in the broadcast video, a broadcast scoreboard is located in a predetermined area of the screen, and the processor 133 may crop a predetermined area of the broadcast video and determine whether a broadcast scoreboard is present in the cropped area. When the value of step S320 equals “yes,” the process proceeds to step S330. When the value of step S320 equals “no”, the process may return to step S310.

In step S330, the processor 133 determines a time period elapsed from a start time of at least one round from the broadcast scoreboard in the reference frame.

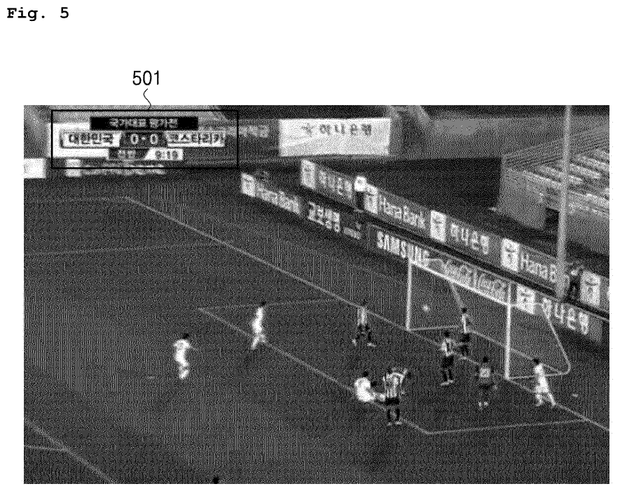

FIG. 5 illustrates a reference frame (e.g., reference frame #2 in FIG. 4) in which a broadcast board 501 is displayed. Referring to FIG. 5, the broadcast scoreboard 501 is located in an upper left corner of a reference frame (#2), and the processor 133 extracts the broadcast scoreboard 501 from the reference frame (#2). Next, the processor 133 applies a text detection algorithm such as optical character recognition (OCR) to the broadcast scoreboard 501 to obtain information on the progress of the game from the broadcast scoreboard 501.

Game progress information that can be directly detected from the broadcast scoreboard 501 includes a round number (indicating a current round from among two or more rounds), a progress time period of a specific round (a time period elapsed from a start time of a specific round), scores of both teams, and the like. For example, names of both teams (‘Korea’, ‘Costa Rica’), a round number (‘first half’), and a time period elapsed from a start time of a round (or game) (‘9:19’), scores of both teams (‘0-0’) are displayed on the broadcast scoreboard 501 in FIG. 5.

In step S340, the processor 133 estimates at least one of the start time and end time of at least one round based on the elapsed time period to generate reference time information including the estimated time. The processor 133 may estimate (identify) a start position of the first half progress section in the broadcast video based on the ‘elapsed time period 9:19’ of the ‘first half’ detected in the broadcast scoreboard 501. That is, the processor 133 may specify a frame having a time code corresponding to the start position of the first half progress section in the broadcast video by inverting 9 minutes and 19 seconds from a time code of the reference frame (#2).

In addition, the game progress information that can be directly detected from the broadcast scoreboard 501 includes a remaining time period until the end of a specific round and a remaining time period until a start time of a next round. For example, the processor 133 may determines not only an end time of the ‘first half’, but also additionally a start time of the ‘second half’, and an end time of the ‘second half’, based on information directly acquired from the broadcast scoreboard 501 of the reference frame (#2). In the case of an event such as soccer, where a regular game time period is specified for each round and a certain amount of additional time period can be given at the discretion of the referee, statistical values (x) such as an average of the additional time period for each event may be stored in advance in the memory 132, and the processor 133 may infer an estimate value (35:41+α) of the end time of the round to which the sampled reference frame belongs, as well as time information (e.g., a remaining time period, 50:41+α, until the start of the second half, a remaining time period, 95:41+α, until the end of the second half) related to a round that follows it using additional time period information and game rule information for each event.

In step S350, the processor 133 removes a game non-progress section from a broadcast video based on the reference time information. That is, the processor 133 may identify a boundary between the game progress section and the game non-progress section of at least one round in the broadcast video based on the reference time information, and set a portion that is not the game progress section as the game non-progress section based on the identified boundary. Referring back to FIG. 4, as described above, ‘game preparation’, ‘halftime’, and ‘wrap-up’ are respectively identified as game non-progress sections. Accordingly, the sections corresponding to the first half and the second half are identified as the game progress sections. The processor 133 may record a time code indicating the start position (RS1, RS2) and end position (RE1, RE2) for each round of the game progress section in the memory 132.

Subsequently, an illustrative execution process of the subroutines of step S240 in which the event detection model is used will be described with reference to FIGS. 6 to 11.

First, the event detection model includes a first deep learning model and a second deep learning model, and each deep learning model may have been trained using a learning data set including a plurality of highlight videos that are extracted from a plurality of different broadcast videos for a game of the same event as a broadcast video selected in step S210 and labeled with one of a plurality of event types.

FIG. 6 a diagram referenced to describe a process in which a plurality of video clips (VC_1 to VC_m) extracted from a game progress section (either one of sections of RS1 to RE1 and RS2 to RE2 or a connection of both thereof in FIG. 4) are converted into a plurality of feature vectors (FV_1 to FV_m) by the first deep learning model of the event detection model. The plurality of video clips (VC_1 to VC_m) may sequentially divide the game progress section every k seconds (e.g., 2 seconds) from the start point. When a frame rate of the video is 30 fps, each video clip includes 30 k frames. A time length of the last video clip may be less than k seconds.

While being executed by the processor 133, the first deep learning model converts the plurality of video clips into the plurality of feature vectors (FV_1 to FV_m) corresponding thereto on a one-to-one basis. That is, each video clip is transformed into a multidimensional vector as it passes through the first deep learning model. Here, a degree of each feature vector may be d (a predetermined value of 2 or more), and a value of d may be determined through a learning process. According to the present disclosure, it is meaningful in that instead of extracting video features on a frame-by-frame basis, a clip-based vector involving (reflecting) temporal information on dynamic motion contained in a game broadcast video is acquired. The feature vector may be a type of feature map, and may be generated by applying logic such as padding to each of two-dimensional image frames included in each video clip and then sorting the results according to a certain rule such as a frame time code order.

Once the plurality of feature vectors (FV_1 to FV_m) are acquired, the processor 133 searches for a portion in the game broadcast video where a specific event occurs from the plurality of feature vectors (FV_1 to FV_m) using the second deep learning model. For this purpose, identification information on a plurality of event types related to an event represented by the broadcast video must be defined in advance, which will be described in detail from now on.

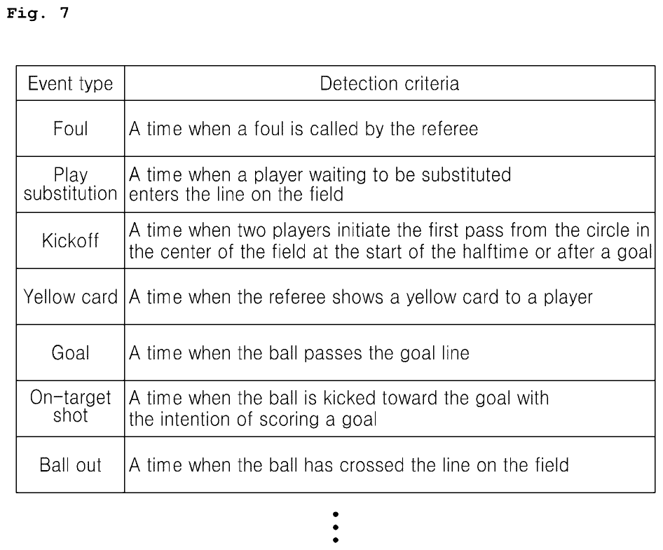

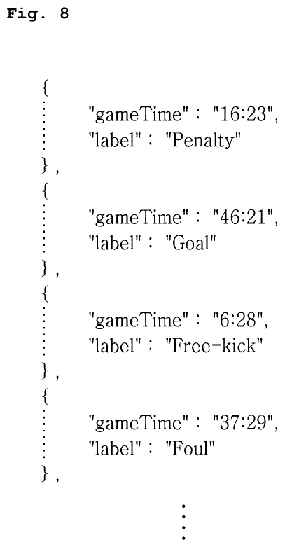

FIG. 7 is a diagram illustrating a plurality of event types predefined for each event and detection criteria for each event type in a table format, and FIG. 8 is a diagram illustratively showing a portion of learning data labeled according to the detection criteria for each event type according to FIG. 7.

Referring to FIG. 7, foul, player substitution, kickoff, yellow card, goal, on-target shot, and ball out are respectively set as a plurality of event types related to ‘soccer’, and detection criteria for each event type are provided. A plurality of event types related to various sports such as ‘soccer’ may be freely determined, and for example, a specific player being close-up for more than a certain percentage of the video frame or the like may be set as an independent event type.

Even when the event type is the same, the time of occurrence may be interpreted differently depending on those who judge, and therefore, as shown in FIG. 7, the detection criteria for each event type may be specified in advance, thereby strengthening indexical nature for accurate event detection from a labeling process on the learning data set.

Learning result data may be acquired from the second deep learning model in a process of training the second deep learning model with any other broadcast video provided as a learning data set. Referring to FIG. 8, it can be seen that from the start of a soccer game, a penalty event occurs at 16 minutes and 23 seconds, a goal event at 46 minutes and 21 seconds, a free kick event at 6 minutes and 28 seconds, and a foul event at 37 minutes and 29 seconds, and labeled, respectively.

Meanwhile, in FIGS. 7 and 8, the game type is specified as ‘soccer’ for convenience of description, but it will be easily understood by those skilled in the art that the present disclosure is not limited to broadcasting videos of ‘soccer’.

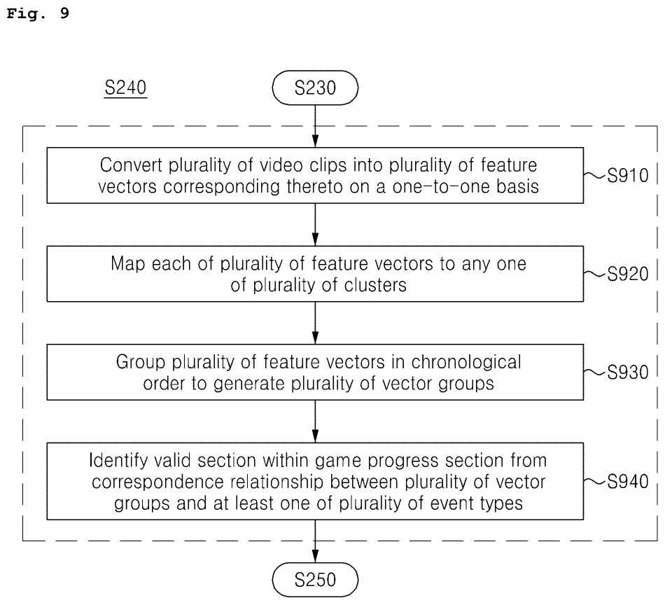

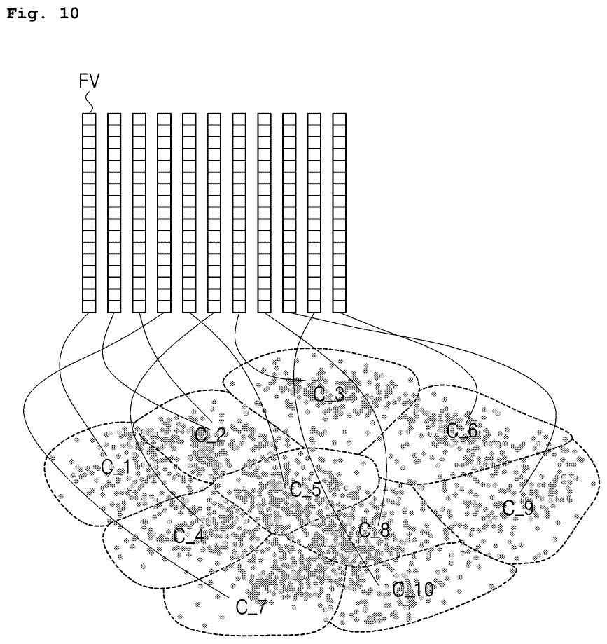

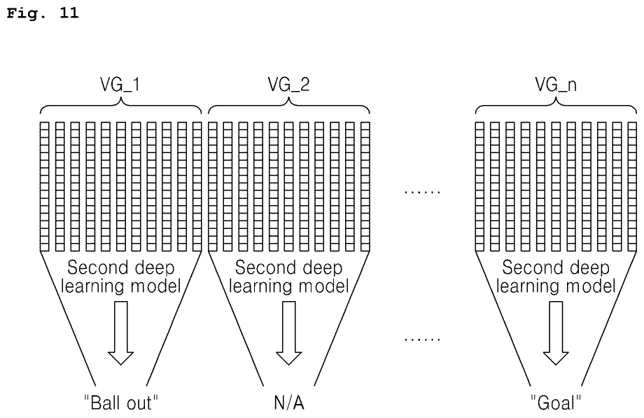

FIG. 9 is a flowchart referenced to describe an illustrative execution process of the subroutines in step S240, FIG. 10 is a diagram illustratively showing a correspondence relationship between a plurality of clusters and a plurality of feature vectors, and FIG. 11 is a diagram referenced to describe a process of performing event detection for each sub-video section of a game progress video from corresponding relationship data according to FIG. 10.

Referring to FIG. 9, in step S910, the processor 133 converts a plurality of video clips into a plurality of feature vectors corresponding thereto on a one-to-one basis using the first deep learning model of the event detection model.

In steps S920 to S940, the second deep learning model of the event detection model is used.

In step S920, the processor 133 maps each of the plurality of feature vectors to any one of a plurality of clusters. Each cluster at least partially represents at least one of the plurality of event types. Referring to FIG. 10, in a training process of the second deep learning model, a number of clusters, a range of each cluster, and a degree of relationship with a plurality of event types may be determined. The processor 133 may classify vectors with similar features from among the plurality of feature vectors (FV_1 to FV_m) into the same cluster using the second deep learning model.

In step S930, the processor 133 groups a plurality of feature vectors in chronological order to generate a plurality of vector groups. In detail, a single feature vector may itself indicate (sufficiently describe) an arbitrary event from among a plurality of event types, but a video clip corresponding to each feature vector typically has a limited time period range that is not sufficient to fully represent a certain event type.

Referring to FIG. 11, when a plurality of feature vectors acquired from the game progress section are input to the second deep learning model, the plurality of feature vectors are grouped by a predetermined number in chronological order by the second deep learning model to generate a plurality of vector groups (VG_1, VG_2, VG_n).

In step S940, the processor 133 identifies a valid section within the game progress section from a correspondence relationship between the plurality of vector groups and at least one of the plurality of event types.

The plurality of video clips (VC_1 to VC_m) are converted one-to-one into a plurality of feature vectors (FV_1 to FV_m), and the plurality of feature vectors (FV_1 to FV_m) are mapped to at least one of the plurality of clusters. Therefore, when a mapping relationship between a plurality of feature vectors and a plurality of clusters is sorted based on the temporal positions of a plurality of video clips, a unique combination of the same number of consecutive clusters for each set of a predetermined number of feature vectors in chronological order may be obtained, and a cluster combination for each vector group will represent any one event type from among the plurality of event types more strongly than the remaining event types. In the present disclosure, the fact that an arbitrary vector group corresponds to a specific event type denotes that the vector group sufficiently represents that specific event type from among the plurality of event types above a threshold level, and the representation level for that specific event type is higher than that for the remaining event types. For an example, how high a level a vector group represents a certain event type may be quantified by the second deep learning model, and when a maximum value from among a plurality of numerical values of the corresponding vector group for the plurality of event types is above a threshold value, it may be determined that the vector group corresponds to a specific event type. At this time, a time period range of the vector group corresponding to a specific event type, that is, a section between the start time and end time of a predetermined number of video clips associated with a predetermined number of feature vectors constituting the vector group, is the valid section.

When two adjacent valid sections correspond to the same event type, the processor 133 may treat (manage) those two valid sections as a single valid section.

The processor 133 may input a plurality of vector groups (VG_1, VG_2, VG_n) to the second deep learning model, and identify whether there is an event type occurring in a time period range for each vector group from among the plurality of event types and what that event type is based on a combination of clusters mapped in chronological order to respective feature vectors belonging to a common vector group. When the event type identification process for the plurality of vector groups (VG_1, VG_2, VG_n) is completed, editing guide information as a result thereof is generated. In FIG. 11, it is illustrated that an event type corresponding to the vector group (VG_1) is “ball out”, an event type corresponding to the vector group (VG_2) is not present, and an event type corresponding to the vector group (VG_n) is “goal”.

By operating the second deep learning model according to the setting information described above with reference to FIG. 2, the processor 133 may selectively identify only valid sections that match the setting information within the game progress section. That is, when only “ball out” and “goal” are specified as event types in the setting information from the editor, even though the vector group (VG_2) actually corresponds to the “yellow card” event, it may be identified that an event type corresponding thereto is not available (“N/A”) as shown in FIG. 11.

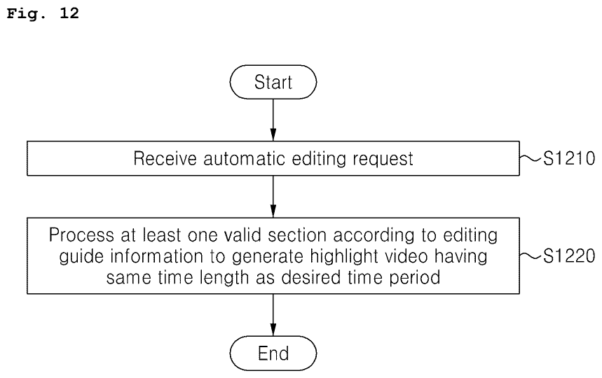

FIG. 12 is a flowchart referenced to illustratively describe an image editing assistance method according to another embodiment of the present disclosure, which is executed by the image editing assistance apparatus shown in FIG. 1. The method of FIG. 12 may be implemented in parallel with the method of FIG. 2.

Referring to FIG. 12, in step S1210, the processor 133 receives an automatic editing request through the input unit 110. The automatic editing request may include a desired time period specified by the user (editor). The desired time period represents a time length of a highlight video that the user ultimately wants to produce. Meanwhile, the automatic editing request according to step S1210 may be received together with setting information for the filtering items described above with reference to FIG. 2, and in this case, step S1210 may be omitted.

In step S1220, the processor 133 processes at least one valid section according to the editing guide information generated in step S240 to generate a highlight video having the same time length as the desired time period.

Specifically, when there is only one valid section according to the editing guide information, a time length of the valid section is compared with the desired time period to process the valid section. For example, when the time length of the valid section is less than the desired time period, the processor 133 may generate a highlight video by connecting a video clip in which the playback speed of the valid section is reduced or the playback speed of the valid section is increased to have a time length equal to a difference between the time length of the valid section and the desired time period to at least one of the start and end positions of the valid section.

Next, when there are two or more valid sections according to the editing guide information, a highlight video may be generated by determining a time length of each valid section according to an event importance for each event type specified in the setting information, and then connecting the processed valid sections to have the determined time length.

For an example, it is assumed that a desired time period is 120 seconds, time lengths of first to third valid sections according to the editing guide information is 60 seconds, respectively, and importances of the first to third valid sections are 1, 2, and 3, respectively (the larger the number is, the higher the importance becomes). In this case, since the time lengths of the valid sections are the same, depending on the importance, allocation time periods for the first to third valid sections are 120/(1+2+3)=20 seconds, 120*2/(1+2+3)=40 seconds and 120*3/(1+2+3)=60 seconds, respectively. As a result, an interconnected highlight video may be generated in which the first valid section is adjusted to 3× speed, the second valid section to 1.5× speed, and the third valid section to the normal speed.

For another example, it is assumed that a desired time period is 120 seconds, time lengths of first to third valid sections according to the editing guide information are 150 seconds, 100 seconds, and 200 seconds, respectively, and importances of the first to third valid sections are 2, 5, and 3, respectively (the larger the number is, the higher the importance becomes). In this case, depending on the time length and importance of each valid section, allocation time periods for the first to third valid sections are 120*(150*2)/(150*2+100*5+200*3)=about 25.7 seconds, 120*(100*5)/(150*2+100*5+200*3)=about 42.9 seconds and 120*(200*3)/(150*2+100*5+200*3)=about 51.4 seconds, respectively. As a result, the first valid section may be adjusted to 150/25.7× speed, the second valid section to 100/42.9× speed, and the third valid section to 200/51.4× speed, and then an interconnected highlight images may be generated.

The calculation method of allocation time periods for processing the valid sections described above is only an example. That is, an allocation time period of any valid section may be modified as long as it is determined to have a positive correlation with the time length and importance of the corresponding valid section.

The present disclosure is not limited to the foregoing specific embodiments and application examples, it will be of course understood by those skilled in the art that various modifications may be made without departing from the gist of the present disclosure as defined in the following claims, and it is to be noted that those modifications should not be understood individually from the technical concept and prospect of the present disclosure.

In particular, configurations that implement the technical features of the present disclosure included in the block diagrams and flowcharts shown in the drawings attached to this specification represent logical boundaries between the configurations. However, according to an embodiment of software or hardware, the shown configurations and functions thereof are executed in the form of stand-alone software modules, monolithic software structures, codes, services, and combinations thereof, and the functions may be implemented by being stored in a medium executable on a computer provided with a processor capable of executing the stored program codes, instructions, and the like, and therefore, all of these embodiments should also be regarded as falling within the scope of the present disclosure.

Accordingly, the accompanying drawings and technologies thereof describe the technical characteristics of the present disclosure, but should not be simply inferred unless a specific array of software for implementing such technical characteristics is clearly described otherwise. That is, the aforementioned various embodiments may be present, and may be partially modified while having the same technical features as those of the present disclosure, and thus such modified embodiments should also be regarded as falling within the scope of the present disclosure.

Furthermore, the flowchart describes operations in the drawing in a specific sequence, but has been shown to obtain the most preferred results, and it should not be understood that such operations must be carried out in the specific sequence or sequential sequence shown, or that all shown operations must be carried out. In a specific case, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

1. An image editing assistance method, the method comprising:
preprocessing a broadcast video of an event for which a game time period for each round is specified to identify a game progress section from which a game non-progress sections has been removed from the broadcast video;
extracting a plurality of video clips from the game progress section; and
analyzing the plurality of video clips using an event detection model to generate editing guide information indicating at least one valid section within the game progress section, the valid section corresponding to at least one of a plurality of event types.

2. The method of claim 1, further comprising:
acquiring the game progress section;
sampling at least one reference frame from the broadcast video;
generating reference time information indicating an estimate value of at least one of a start time and an end time of at least one round in the broadcast video based on the reference frame; and
removing the game non-progress section from the broadcast video based on the reference time information.

3. The method of claim 2, wherein the generating of the reference time information comprises:
extracting a broadcast scoreboard from the reference frame;
determining, from the broadcast scoreboard, an elapsed time period from the start time of at least one round; and
estimating, based on the elapsed time period, at least one of a start time and an end time of at least one round.

4. The method of claim 1, wherein the event detection model is trained by a learning data set including a plurality of highlight videos extracted from a plurality of different videos of the same event and labeled with any one of the plurality of event types.

5. The method of claim 1, wherein between two adjacent video clips of the plurality of video clips, an end time of a preceding video clip is subsequent to a start time of a following video clip.

6. The method of claim 1, wherein the generating of the editing guide information comprises:
converting the plurality of video clips into a plurality of feature vectors corresponding thereto on a one-to-one basis, using a first deep learning model of the event detection model; and
following operations using a second deep learning model of the event detection model:
mapping each of the plurality of feature vectors to any one of a plurality of clusters, each cluster at least partially representing at least one of the plurality of event types;
grouping the plurality of feature vectors in chronological order to generate a plurality of vector groups; and
identifying the valid section within the game progress section from a correspondence relationship between the plurality of vector groups and at least one of the plurality of event types.

7. The method of claim 6, further comprising:
receiving setting information on at least one of a plurality of filtering items used to extract a highlight video from the broadcast video,
wherein the second deep learning model is operated according to the setting information.

8. The method of claim 7, wherein the plurality of filtering items comprises an event type, an event similarity, and an event importance.

9. The method of claim 1, further comprising:
outputting an image editing interface presented with the editing guide information,
wherein the image editing interface comprises an indicator indicating the location or range of the valid section in the broadcast video.

10. The method of claim 1, further comprising:
processing, in response to receiving an automatic editing request specified with a desired time period from a user, the at least one valid section to generate a recommended highlight video having the same time length as the desired time period.

11. An image editing assistance apparatus, the apparatus comprising:
a memory that stores a computer program in which instructions for executing an image editing assistance method are recorded and a broadcast video of an event for which a game time period for each round is specified; and
a processor operably coupled to the memory,
wherein when the computer program is executed by the processor, the processor is configured to preprocess the broadcast video to acquire a game progress section from which a game non-progress sections has been removed from the broadcast video, extract a plurality of video clips from the game progress section, and analyze the plurality of video clips using an event detection model to generate editing guide information indicating at least one valid section within the game progress section, the valid section corresponding to at least one of a plurality of event types.

12. The apparatus of claim 11, wherein, in order to identify the game progress section, the processor is configured to sample at least one reference frame from the broadcast video, generate reference time information representing an estimate value of at least one of a start time and an end time of at least one round in the broadcast video based on the reference frame, and remove the game non-progress section from the broadcast video based on the reference time information.

13. The apparatus of claim 12, wherein, in order to generate the reference time information, the processor is configured to extract a broadcast scoreboard from the reference frame, determine, from the broadcast scoreboard, an elapsed time period from a start time of at least one round, and estimate, based on the elapsed time period, at least one of a start time and an end time of at least one round.

14. The apparatus of claim 11, wherein, in order to generate the editing guide information, the processor is configured to convert the plurality of video clips into a plurality of feature vectors corresponding thereto on a one-to-one basis using a first deep learning model of the event detection model, map each of the plurality of feature vectors to any one of a plurality of clusters, each cluster at least partially representing at least one of the plurality of event types, using a second deep learning model of the event detection model, group the plurality of feature vectors in chronological order to generate a plurality of vector groups, and identify the valid section within the game progress section from a correspondence relationship between the plurality of vector groups and at least one of the plurality of event types.

15. The apparatus of claim 14, wherein the processor is configured to operate, when receiving setting information on at least one of a plurality of filtering items used to extract a highlight video from the broadcast video, the second deep learning model according to the setting information.
